(19) United States
(12) Patent Application Publication
(10) Pub. No.: US 2024/0266132 A1
(43) Pub. Date: Aug. 8, 2024

(54) GRADIENT BRIDGE CROSS-SECTION FOR IMPROVED THERMAL & OSR FUSE PERFORMANCE

(71) Applicant: Littelfuse, Inc., Chicago, IL (US)

(72) Inventors: Scott Faust, Pesotum, IL (US); Christopher H. Jones, Effingham, IL (US)

(73) Assignee: Littelfuse, Inc., Chicago, IL (US)

(21) Appl. No.: 18/433,857

(22) Filed: Feb. 6, 2024

Related U.S. Application Data
(60) Provisional application No. 63/483,633, filed on Feb. 7, 2023.

(51) Int. Cl. H01H 85/08

(52) U.S. Cl. CPC H01H 85/08

(57) ABSTRACT

A fuse element includes a bridge assembly located adjacent one side of a center portion. The bridge assembly includes multiple bridges connected to a fuse terminal. Each bridge has a cross-sectional area different from each other bridge. A first bridge is adjacent the center portion and has a first cross-sectional area. A last bridge is adjacent the fuse terminal and has a second cross-sectional area greater than the first cross-sectional area.

### CROSS-REFERENCE TO CORRESPONDING APPLICATIONS

The present application claims the benefit of priority under 35 U.S.C. §119 to U.S. Provisional Application Serial No. 63/483,633, titled “GRADIENT BRIDGE CROSS-SECTION FOR IMPROVED THERMAL & OSR FUSE PERFORMANCE” and filed Feb. 7, 2023, the disclosure of which is incorporated herein by reference in its entirety.

### FIELD OF THE DISCLOSURE

Embodiments of the present disclosure relate to fuse arcing and, more particularly, to fuse designs to improve open-state resistance.

### BACKGROUND

Used in electrical systems to protect against excessive current, fuses are sacrificial devices which break when an overcurrent condition occurs. Fuses include a fuse element, such as a metal wire or strip, that links two metal contact terminals together, and which melts/breaks if too much current flows. The breakage causes an open circuit, thus protecting devices to which the fuse is connected. Fuses come in a variety of shapes and sizes and have many applications, from small circuit electronics to large-scale industrial applications. In addition to being a component protection device, fuses are also safety devices, such as when used in vehicles, as they protect against fires in response to vehicle accidents.

One important fuse performance metric is open-state resistance (OSR), which is the measured electrical resistance across the terminals of the fuse once opened due to breakage. The OSR metric is used to benchmark leakage current, which is the amount of current, at regular operating voltage, which passes through the fuse following an opening event. For the electric vehicle (EV) fuses, product specifications typically require a maximum leakage current of 0.5 milliamperes, which in turn generally require a minimum OSR values in the megaohm range. In practice, the stochastic nature of high-power opening events results in expected OSR distribution spanning at least six orders of magnitude. For this reason, designs that maximize OSR are valuable.

Fuses having fuse elements which are an assembly or array of bridges tend to burn all at once during fuse breakage due to a high current fault condition (opening event). Each bridge burns at the same time, leaving deposits of melted copper (the bridges of the fuse element) and surrounding fulgurite (the melted sand used as filler). If the melted copper is somewhat uniform between the fuse terminals, a path across which current flows can result, despite the fuse having blown. This is contrary to the fuse's purpose of preventing current flow to the protected circuitry.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a fuse element assembly in accordance with the present disclosure may include a fuse element located between two terminals made of electrically conductive material. The fuse element has a center portion and a bridge assembly. The bridge assembly is located between the center portion and one of the terminals. The bridge assembly includes two bridges, the first bridge having a first quantity of electrically conductive material and the second bridge having a second quantity of electrically conductive material. The first bridge is sandwiched between the second bridge and the center portion. The second quantity of electrically conductive material is greater than the first quantity.

An exemplary embodiment of a fuse element in accordance with the present disclosure may include a bridge assembly located adjacent one side of a center portion. The bridge assembly includes multiple bridges connected to a fuse terminal. Each bridge has a cross-sectional area different from each other bridge. A first bridge is adjacent the center portion and has a first cross-sectional area. A last bridge is adjacent the fuse terminal and has a second cross-sectional area greater than the first cross-sectional area.

An exemplary embodiment of a fuse element in accordance with the present disclosure may include a bridge assembly located between a terminal and a center portion. The bridge assembly has multiple bridges. Upon the occurrence of a high current fault condition (opening event), in a first time period, a first bridge of the bridge assembly arcs, then melts into a first melted copper deposit having a first area. In a second time period, a second bridge of the bridge assembly arcs, then melts into a second melted copper deposit having a second area. The first bridge is closer to the center portion than the second bridge and the first time period is before the second time period.

### BRIEF DESCRIPTION OF THE DRAWINGS

FIGS. 1A-1B are diagrams illustrating a fuse element assembly, in accordance with the prior art;

FIGS. 2A-2B are diagrams illustrating a fuse element assembly, in accordance with exemplary embodiments;

FIGS. 3A-3B are diagrams illustrating bridge assemblies, in accordance with exemplary embodiments;

FIGS. 4A-4B are diagrams illustrating bridge assemblies, in accordance with exemplary embodiments;

FIGS. 5A-5B are diagrams illustrating x-rays of the fuse element assembly of FIG. 2A, in accordance with exemplary embodiments

FIG. 6 is a diagram of a simulated short circuit of the fuse element assembly of FIG. 1A, according to the prior art; and

FIG. 7 is a diagram of a simulated short circuit of the fuse element assembly of FIG. 2A, according to exemplary embodiments.

### DETAILED DESCRIPTION

A fuse element assembly is disclosed herein to improve fuse behavior during an opening event. The fuse element assembly includes bridge assemblies on either side of a center portion, with one bridge assembly being disposed between the center portion and one terminal and the other bridge assembly being disposed between the center portion and the other terminal. Each bridge assembly has multiple bridges. The bridges are configured so that the quantity (amount) of electrically conductive material making up each bridge changes, based on the distance of the bridge from the center portion. Bridges closest the center portion (on either side) will have the smallest quantity of electrically conductive material, with each succeeding bridge farther away from the center portion having an increasing quantity of electrically conductive material, with the bridges farthest from the center portion (on either side) and closest the terminals having the largest quantity of electrically conductive material. During a breakage event in which the fuse terminal experiences melting, followed by arcing, then followed by further melting, the bridges closest the center portion will arc, then melt first, followed by the adjacent bridges, and so on, until all bridges have arced, followed by melting. The effect is to better disperse melted copper material through extended arcing at the center of the fuse, while avoiding uniform distribution of melted copper material between the terminals that characterizes legacy fuses.

For the sake of convenience and clarity, terms such as “top”, “bottom”, “upper”, “lower”, “vertical”, “horizontal”, “lateral”, “transverse”, “radial”, “inner”, “outer”, “left”, and “right” may be used herein to describe the relative placement and orientation of the features and components, each with respect to the geometry and orientation of other features and components appearing in the perspective, exploded perspective, and cross-sectional views provided herein. Said terminology is not intended to be limiting and includes the words specifically mentioned, derivatives therein, and words of similar import.

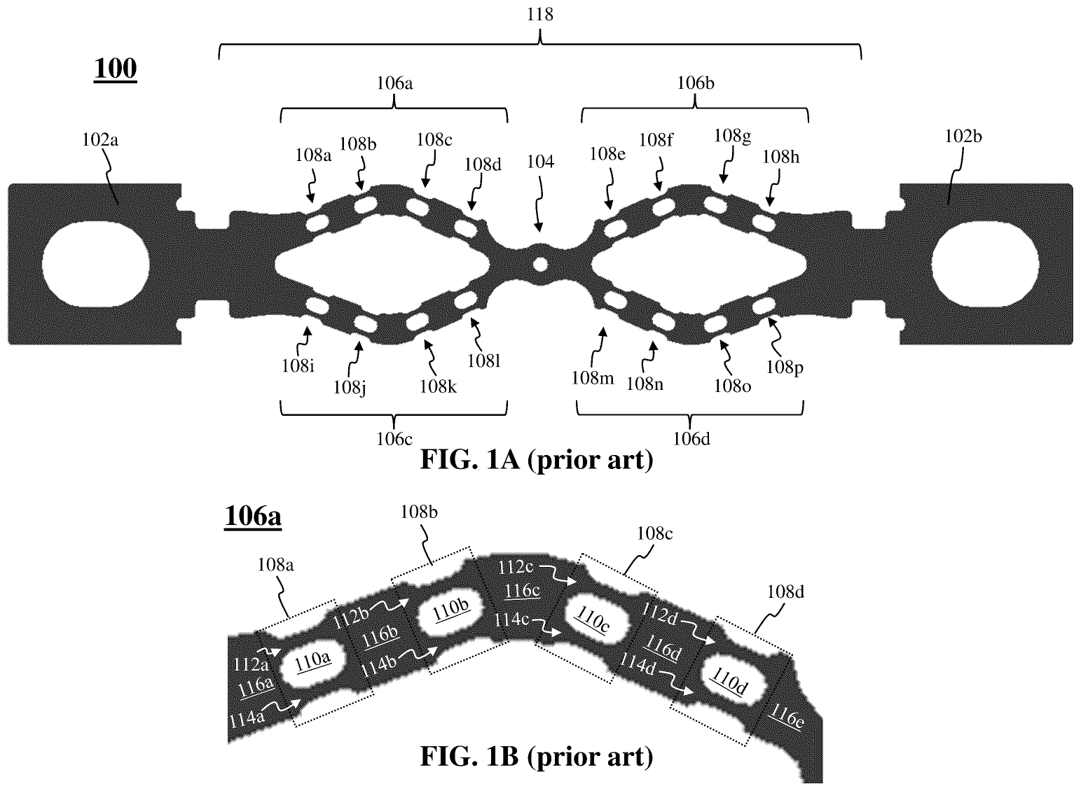

FIGS. 1A-1B are representative drawings of a fuse element assembly 100, according to the prior art. FIG. 1A is an overhead view of the fuse element assembly 100 and FIG. 1B is a detail view of a bridge assembly portion of the fuse element assembly. The fuse element assembly 100 features a fuse element 118 disposed between two terminals 102a and 102b (collectively, “terminals 102”). The fuse element assembly 100 is part of a fuse designed to break in response to an overcurrent event. The fuse element 118 is typically contained within a housing (not shown), with the terminals 102 extending from either side of the housing. The housing may be packed with a filler material, such as sand.

The fuse element 118 consists of four bridge assemblies 106a-d and a center 104, with bridge assemblies 106a and 106c being on a first side of the center 104 and bridge assemblies 106b and 106d (collectively, “bridge assemblies 106”) being on a second side of the center 104, the second side being opposite the first side. Further, bridge assembly 106a and bridge assembly 106c are disposed between terminal 102a and center 104 and form a diamond shape on the first side of center 104. Similarly, bridge assembly 106b and bridge assembly 106d are disposed between center 104 and terminal 102b and forming a diamond shape on the second side of center 104.

The fuse element assembly 100 is made of an electrically conductive material such as copper. Generally, the fuse element assembly 100 is stamped from a sheet of copper so that the terminals 102 and fuse element 118 are a single, unitary structure. As the intentional weak link of a fuse, the fuse element 118, including the bridge assemblies 106, are designed to facilitate dispersion of materials following the high current fault condition , also known herein as an opening event. During the opening event, the bridge assembly melts, the melting causes a separation of the metal, then an arc forms between the two metals, and the arc causes the remaining fuse material to melt and disperse into the surrounding filler, all in a very short time frame.

During an opening event, the solid copper of the fuse element assembly 100 is melted and dispersed in liquid particulates through the molten filler material by the pressure of the electrical arc plasma. Following opening, the fuse contents cool and solidify into fulgurite (primarily fused sand) interspersed with solid particulates of copper. The copper is the only fuse component with appreciable electrical conductance and is thus the primary charge carrier allowing for lower open-state resistance (OSR) values.

Each bridge assembly 106 of the fuse element assembly 100 includes multiple interconnected bridges. Bridge assembly 106a features bridges 108a, 108b, 108c, and 108d, with bridge 108a being adjacent bridge 108b, bridge 108b being adjacent bridge 108c, and bridge 108c being adjacent bridge 108d. Bridges 108a and 108b are oriented in a first disposition while bridges 108c and 108d are oriented in a second disposition, with the first disposition and the second disposition forming an acute angle as one portion of the diamond shape disposed at the first side of the center 104. Bridge assembly 106b features bridges 108e, 108f, 108g, and 108h, with bridge 108e being adjacent bridge 108f, bridge 108f being adjacent bridge 108g, and bridge 108h being adjacent bridge 108g. Bridges 108e and 108f are oriented in a first disposition while bridges 108g and 108h are oriented in a second disposition, with the first disposition and the second disposition forming an acute angle as one portion of the diamond shape disposed at the second side of the center. Bridge assemblies 106c (with bridges 108i, 108j, 108k, and 108l) and 106d (with bridges 108m, 108n, 108o, and 108p) (collectively, “bridges 108”) are essentially mirror images of bridge assemblies 106a and 106b. Along with bridge assembly 106a, bridge assembly 106c forms the diamond shape disposed at the first side of the center 104. Along with bridge assembly 106b, bridge assembly 106d forms the diamond shape disposed at the second side of the center 104.

A detailed view of bridge assembly 106a is shown in FIG. 1B, where it is understood that the bridge assemblies 106b, 106c, and 106d are similarly configured. The bridge assembly 106a features bridges 108a, 108b, 108c, and 108d, with bridges 108a and 108b being in a first disposition and bridges 108c and 108d being at a second disposition, with the first disposition and second disposition forming an acute angle. Each bridge 108 (indicated with dotted rectangle) features an aperture, a bridge top, and a bridge bottom. Bridge 108a includes aperture 110a, bridge top 112a, and bridge bottom 114a; bridge 108b includes aperture 110b, bridge top 112b, and bridge bottom 114b; bridge 108c includes aperture 110c, bridge top 112c, and bridge bottom 114c; and bridge 108d includes aperture 110d, bridge top 112d, and bridge bottom 114d (collectively, “apertures 110”, “bridge tops 112”, and “bridge bottoms 114”).

The bridge assembly 106a also features connectors 116a-e, with aperture 110a being sandwiched between connector 116a and 116b, aperture 110b being sandwiched between connector 116b and 116c, aperture 110c being sandwiched between connector 116c and 116d, and aperture 110d being sandwiched between connector 116d and 116e (collectively, “connectors 116”). The bridge assemblies 106b, 106c, and 106d are similarly configured with apertures 110 disposed between connectors 116. The connector 116e links with the center 104 while the connector 116a links with the terminal 102a.

While the dimensions of connectors 116b and 116d are similar, the connector 116c is different to account for the acute angle between bridge pairs 108a/108b and 108c/108d. However, the bridge tops 112 and the bridge bottoms 114 of the bridge assemblies 106 have the same dimension. Each bridge top 112 has the same area as the other bridge tops; each bridge bottom 114 has the same area as the other bridge bottoms. Put another way, the quantity (amount) of copper forming each bridge top 112a, 112b, 112c, and 112d is substantially the same and the quantity of copper forming each bridge bottom 114a, 114b, 114c, and 114d is substantially the same. What this means is that, upon the occurrence of an opening event, each bridge 108 of the bridge assembly 106 will experience arcing and the same instant and will therefore melt simultaneously. Further, all of the bridge 108 of the fuse element assembly 100 will experience arcing at the same instant and will therefore melt simultaneously. By having the same cross section at each “weak point” (bridge), the geometry will force nearly equal arcing through each of the points of the fuse element assembly 100 during a short circuit. Unfortunately, this characteristic of the fuse element assembly 100 results in uniform dispersion of the melted copper along the length of the fuse element 118, which also happens to be the current path. The uniform dispersion of copper along the path between the two terminals 102 may allow current to flow between the two terminals 102 of the fuse element assembly 100, despite the occurrence of the opening event.

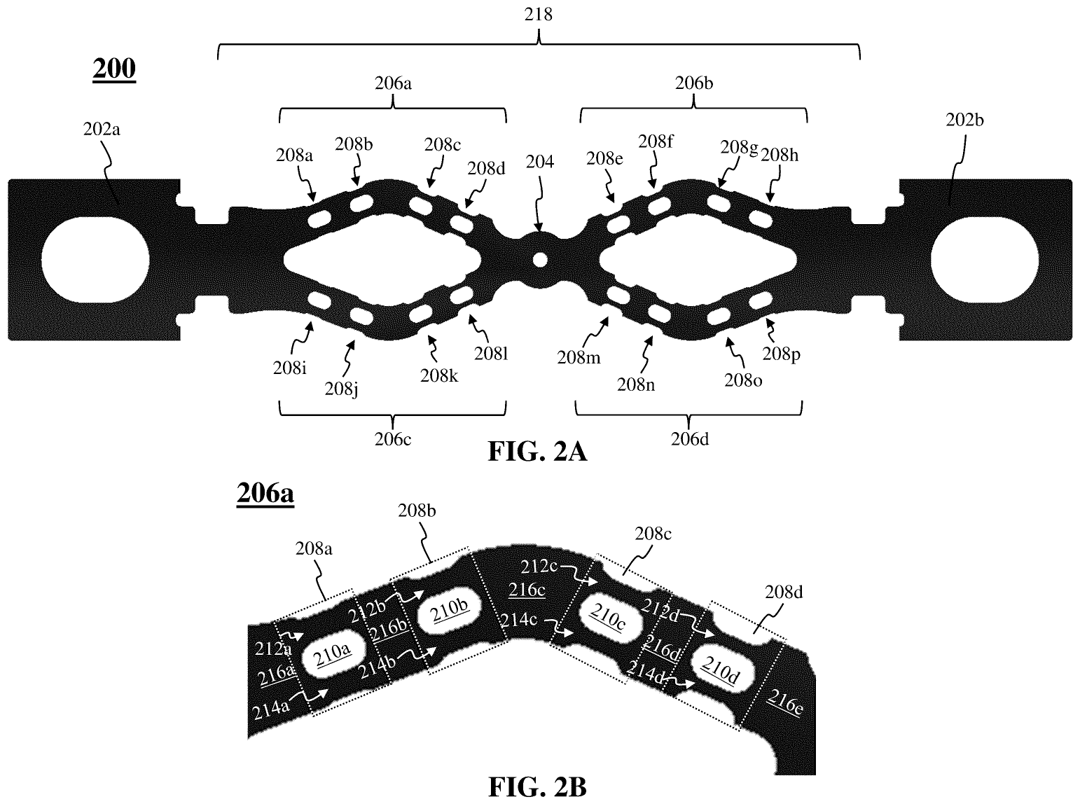

FIGS. 2A-2B are representative drawings of a fuse element assembly 200, according to exemplary embodiments. FIG. 2A is an overhead view of the fuse element assembly 200 and FIG. 2B is detail view of a bridge assembly portion of the fuse element assembly. The fuse element assembly 200 features a fuse element 218 disposed between two terminals 202a and 202b (collectively, “terminals 202”). Like the fuse element assembly 100, the fuse element assembly 200 is part of a fuse designed to break in response to an overcurrent event. The fuse element 218 is contained within a housing (not shown), with the terminals 202 extending from either side of the housing. The housing may be packed with a filler material, such as sand.

The fuse element 218 consists of four bridge assemblies 206a-d and a center 204, with bridge assemblies 206a and 206c being on a first side of the center 204 and bridge assemblies 206b and 206d (collectively, “bridge assemblies 206”) being on a second side of the center 204, the second side being opposite the first side. Bridge assembly 206a and bridge assembly 206c are disposed between terminal 202a and center 204, with bridge assembly 206a and bridge assembly 206c forming a diamond shape on the first side of center 204. Similarly, bridge assembly 206b and bridge assembly 206d are disposed between center 204 and terminal 202b, with bridge assembly 206b and bridge assembly 206d forming a diamond shape on the second side of center 204.

The fuse element assembly 200 is made of an electrically conductive material such as copper. The fuse element assembly 200 is typically stamped from a sheet of copper so that the terminals 202 and fuse element 218 are a single, unitary structure. As the intentional weak link of a fuse, the fuse element 218, including the bridge assemblies 206, are designed to facilitate dispersion of materials following the opening (fuse breakage) event

Each bridge assembly 206 includes multiple interconnected bridges. Bridge assembly 206a features bridge 208a, 208b, 208c, and 208d, with bridge 208a being adjacent bridge 208b, bridge 208b being adjacent bridge 208c, and bridge 208c being adjacent bridge 208d. Put another way, bridge 208a is sandwiched between terminal 202a and bridge 202b, bridge 202b is sandwiched between bridge 208a and bridge 208c, bridge 208c is sandwiched between bridge 208b and bridge 208d, and bridge 208d is sandwiched between bridge 208c and center 204.

Bridges 208a and 208b are oriented in a first disposition while bridges 208c and 208d are oriented in a second disposition, with the first disposition and the second disposition forming an acute angle as one portion of the diamond shape disposed at the first side of the center 204. Bridge assembly 206b features bridges 208e, 208f, 208g, and 208h, with bridge 208e being adjacent bridge 208f, bridge 208f being adjacent bridge 208g, and bridge 208h being adjacent bridge 208g. Bridges 208e and 208f are oriented in a first disposition while bridges 208g and 208h are oriented in a second disposition, with the first disposition and the second disposition forming an acute angle as one portion of the diamond shape disposed at the second side of the center.

Bridge assemblies 206c (with bridges 208i, 208j, 208k, and 208l) and 206d (with bridges 208m, 208n, 208o, and 208p) (collectively, “bridges 208”) are essentially mirror images of bridge assemblies 206a and 206b, with bridge assembly 206c forming the second portion of the diamond shape disposed at the first side of the center 204 and bridge assembly 206d forming the second portion of the diamond shape at the second side of the center.

A detailed view of bridge assembly 206a is shown in FIG. 2B, where it is understood that the bridge assemblies 206b, 206c, and 206d are similarly configured. The bridge assembly 206a features bridges 208a, 208b, 208c, and 208d, with bridges 208a and 208b being in a first disposition and bridges 208c and 208d being at a second disposition, with the first disposition and second disposition forming an acute angle. Each bridge 208 (indicated with dotted rectangle) features an aperture, a bridge top, and a bridge bottom. Bridge 208a includes aperture 210a, bridge top 212a, and bridge bottom 214a; bridge 208b includes aperture 210b, bridge top 212b, and bridge bottom 214b; bridge 208c includes aperture 210c, bridge top 212c, and bridge bottom 214c; and bridge 208d includes aperture 210d, bridge top 212d, and bridge bottom 214d (collectively, “apertures 210”, “bridge tops 212”, and “bridge bottoms 214”).

The bridge 206a also features connectors 216a-e, with aperture 210a being sandwiched between connector 216a and 216b, aperture 210b being sandwiched between connector 216b and 216c, aperture 210c being sandwiched between connector 216c and 216d, and aperture 210d being sandwiched between connector 216d and 216e (collectively, “connectors 216”). The bridges 206b, 206c, and 206d are similarly configured with apertures 210 disposed between connectors 216. The connector 216e links with the center 204 while the connector 216a links with the terminal 202a. While the dimensions of connectors 216b and 216d are similar, the connector 216c is different to account for the acute angle between bridge pairs 208a/208b and 208c/208d.

In exemplary embodiments and in contrast to fuse element assembly 100, the cross-sections of the bridge tops 212 and the bridge bottoms 214 of the bridges 206 have sequentially decreasing dimensions, based on the location of each bridge relative to the center 204, where dimension generally means “quantity of copper”. Bridge top 212a has a first cross-sectional dimension, d₁, bridge top 212b has a second cross-sectional dimension, d₂ , bridge top 212c has a third cross-sectional dimension, d₃ , and bridge top 212d has a fourth cross-sectional dimension, d₄, where d₁ >d₂ >d₃ >d₄ . Put another way, the cross-sectional dimension of each bridge top 212 increases as the distance of that bridge from the center 204 increases, and this is true for each bridge assembly 206.

Thus, the quantity of copper forming each bridge top 212a, 212b, 212c, and 212d is sequentially reduced based on the distance from the center 204. The number of bridges 208 and the number of bridge assemblies 206 is merely illustrative and not meant to be limiting, as the principles herein may be applied to fuse element assemblies having many different configurations, whether there is a single bridge assembly on each side of the center, or multiple bridge assemblies extending outward from the center, and irrespective of the number of bridges populating each bridge assembly.

For the fuse element assembly 200 of FIG. 2A, the bridge tops 212 closest to the center 204 (bridge tops of bridges 208d, 208e, 208l, and 208m) have the smallest cross-sectional dimension, d₁ , the bridge tops second closest to the center 204 (bridge tops of bridges 208c, 208f, 208k, and 208n) have the next smallest cross-sectional dimension, d₂ , the bridge tops third closest to the center 204 (bridge tops of bridges 208b, 208f, 208j, and 208o) have the third smallest cross-sectional dimension, d₃ , and the bridge tops farthest from the center 204 (bridge tops of bridges 208a, 208h, 208i, and 208p) have the largest cross-sectional dimension, d₄ . The cross-section at the innermost bridges (208d, 208e, 208l, and 208m) are the smallest, with the cross-section of each succeeding bridge increasing. The fuse element assembly 200 may thus be thought of as a gradient fuse element, with the differing cross-sections of the bridges decreasing the likelihood of a conductive path forming between the terminals.

In exemplary embodiments, this principle similarly applies to the bridge bottoms 214. Thus, bridge bottom 214a has a first cross-sectional dimension, d₅ , bridge bottom 214b has a second cross-sectional dimension, d₆ , bridge bottom 214c has a third cross-sectional dimension, d₇, and bridge bottom 214d has a fourth cross-sectional dimension, d₈, where d₅>d₆>d₇>d₈ . Again, the cross-sectional dimension of each bridge bottom 214 increases as the distance of its bridge from the center 204 increases, and this is true for each bridge assembly 206.

For the fuse element assembly of FIG. 2A, the bridge bottom 214 closest to the center 204 (bridge bottoms of bridges 208d, 208e, 208l, and 208m) have the smallest cross-sectional dimension, d₅ , the bridge bottoms second closest to the center 204 (bridge bottoms of bridges 208c, 208f, 208k, and 208n) have the next smallest cross-sectional dimension, d₆ , the bridge bottoms third closest to the center 204 (bridge bottoms of bridges 208b, 208f, 208j, and 208o) have the third smallest cross-sectional dimension, d₇ , and the bridge bottoms farthest from the center 204 (bridge bottoms of bridges 208a, 208h, 208i, and 208p) have the largest cross-sectional dimension, d₈ . In a non-limiting embodiment, the dimensions of respective bridge tops 212 and bridge bottoms 214 are the same: d₁=d₅, d₂=d₆, d₃=d₇, and d₄=d₈ .

Yet another way to describe the exemplary fuse element assembly 200 is in terms of the entire bridge 208, including bridge tops 212, bridge bottoms 214, and even part of the connectors 216 on either side of the bridge. In exemplary embodiments, the total area of each bridge 208 is modified, depending upon the distance of that bridge from the center 204, with the quantity of copper forming each bridge being sequentially reduced based on the distance from the center 204.

In exemplary embodiments, the occurrence of an opening event for the fuse element assembly 200 is different than that of the legacy fuse element assembly 100. In exemplary embodiments, the opening events (melting, followed by arcing, followed by further melting), will occur to the bridges 208 not simultaneously, but sequentially. The bridges closest to the center 204 (208d, 208e, 208l, and 208m) will experience arcing and will melt first, followed by the bridge 208c, 208f, 208k, and 208n, followed by the bridges 208b, 208g, 208j, and 208o, then followed finally by the bridges 208a, 208h, 208i, and 208p.

The design of the exemplary fuse element assembly 200 thus forces the sequence of arcing events to take place in a linear order created by a gradient in cross-sections, starting from the inner most element bridge and increasing at each location further out from the center. The effect of this design is increasing energy needed to melt the bridges moving sequentially outwards from the center, which allows the previous bridge (the adjacent bridge closer to the center) to arc for a longer period, dispersing copper particulate further into the filler and creating a region of high resistance when the fulgurite cools. In exemplary embodiments, fuse performance is also enhanced by this gradient by forcing most of the arcing to take place in the center of the fuse, with each bridge outward having less available arcing energy due to the extended melt times, which minimizes the chances of arcing through the end of the fuse.

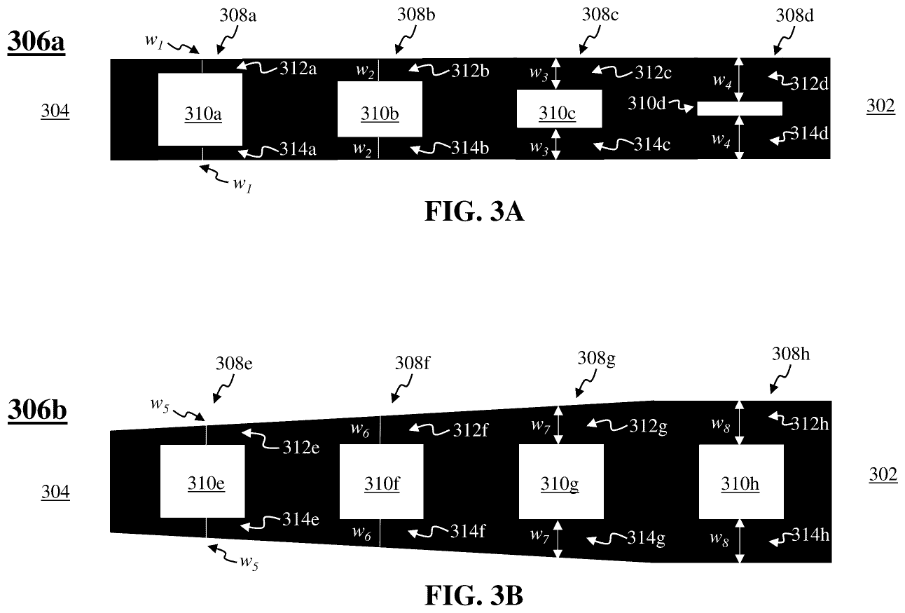

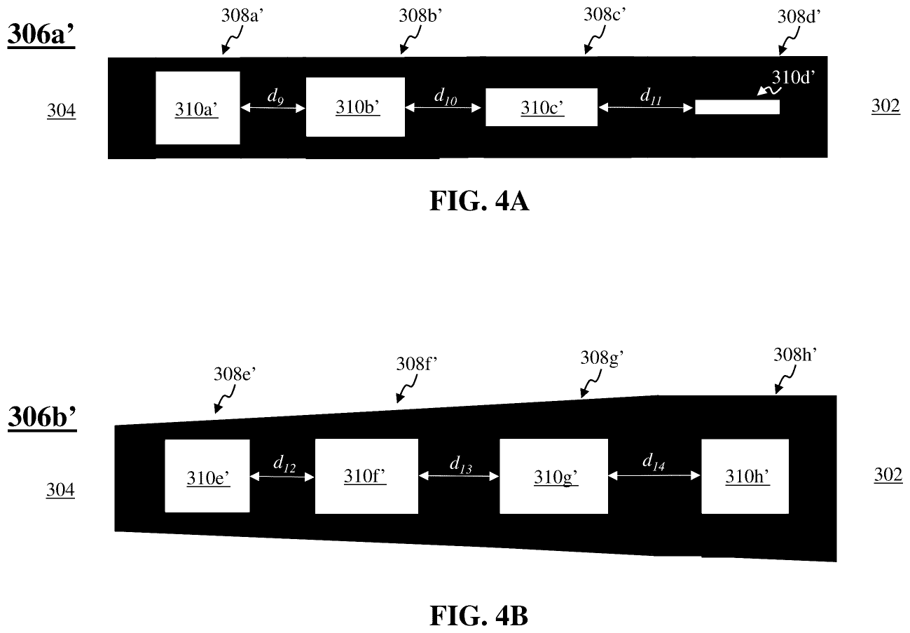

FIGS. 3A-3B and 4A-4B show some of the mechanisms by which the bridges of the fuse element assembly may be manipulated to achieve a gradient cross-section of adjacent bridges, thus ensuring the desired sequential behavior during the opening event. These examples are not exhaustive, as designers of ordinary skill in the art will recognize a number of different ways the gradient cross-section of the fuse element assembly can be achieved.

FIGS. 3A-3B are representative drawings of bridge assemblies 306 used to illustrate mechanisms for creating bridges that will arc and melt sequentially, according to exemplary embodiments. FIG. 3A is a bridge assembly 306a with an aperture gradient and FIG. 3B is a bridge assembly 306b with a top/bottom gradient. Although each bridge assembly 306 includes four bridges, the principals described herein may apply to bridges having 2 through N bridges, for integer, N.

The bridge assembly 306a (FIG. 3A) features bridges 308a, 308b, 308c, and 308d, with each bridge having a respective aperture 310a, 310b, 310c, and 310d and bridge assembly 306b (FIG. 3B) features bridges 308e, 308f, 308g, and 308h, with each bridge having a respective aperture 310e, 310f, 310g, and 310h (collectively, “bridges 308” and “apertures 310”). For ease of explanation, the apertures 310 are shown as simple rectangular shapes, although fuse element assemblies implementing the principles described herein may assume any of a myriad of different shapes. Each bridge has a bridge top and a bridge bottom. Bridge 308a, for example, features bridge top 312a and bridge bottom 314a, bridge 308b features bridge top 312b and bridge bottom 314b, and so on (collectively, “bridge tops 312” and “bridge bottoms 314”). In a non-limiting embodiment, for ease of explanation, the bridge tops 312 and respective bridge bottoms 314 have the same dimension.

In the bridge assembly 306a (FIG. 3A), bridge 308a is adjacent a center 304 of a hypothetical fuse element assembly while bridge 308d is adjacent a terminal 302. The apertures 310 of the bridge assembly 306a decrease in size for each bridge, based on its location relative to the center. Thus, aperture 310a is largest, followed by aperture 310b, followed by aperture 310c, and aperture 310d is the smallest of the four apertures. The modification of the aperture size changes the area of the bridge tops 312 and bridge bottoms 314. Thus, bridge 308a has a bridge top 312a and bridge bottom 314a, each with a cross-section of area, w₁ , bridge 308b has a bridge top 312b and bridge bottom 314b, each with a cross-section of area, w₂ , bridge 308c has a bridge top 312c and bridge bottom 314c, each with a cross-section of area, w₃ , and bridge 308d has a bridge top 312d and bridge bottom 314d, each with a cross-section of area, w₄, where w₁<w₂<w₃<w₄ . Thus, by varying the size of each aperture 310 in the bridge assembly 306a, the desired results are achieved, namely, that the areas of cross-sections of bridge tops 312 and bridge bottoms 314 vary based on the distance of the bridges 308 from the center 304. Put another way, the quantity of copper contained in each bridge 308 varies based on its distance from the center 304, with bridge 308a having the least quantity of copper (and thus arcing and melting first) while bridge 308d has the most quantity of copper (and thus arcing and melting last).

In the bridge assembly 306b (FIG. 3B), bridge 308e is adjacent the center 304 of the hypothetical fuse element assembly while bridge 308h is adjacent the terminal 302. In contrast to the bridge assembly 306a, the apertures 310 of the bridge assembly 306b do not change in size for each bridge 308 but are constant (as in the fuse element assembly 200). Instead, the cross-sections of the bridge tops and bridge bottoms are varied in size. Thus, bridge top 312e and bridge bottom 314e are smallest, each with a cross-section of area, w₅, followed by bridge top 312f and bridge bottom 314f (each with a cross-section of area, w₆), followed by bridge top 312g and bridge bottom 314g (each with a cross-section of area, w₇), and bridge top 312h and bridge bottom 314h are the largest of the four bridge top/bridge bottom pairs (each with a cross-section of area, w₈), where w₅<w₆<w₇<w₈. Again, the quantity of copper contained in each bridge 308 varies based on its distance from the center 304, with bridge 308e having the least quantity of copper (and thus arcing and melting first) while bridge 308h has the most quantity of copper (and thus arcing and melting last).

FIGS. 4A-4B are representative drawings of the bridge assemblies 306 of FIGS. 3A-3B, respectively, in which the distance between apertures varies, according to exemplary embodiments. FIG. 4A is the bridge assembly 306a′ with an aperture gradient and FIG. 4B is the bridge assembly 306b′ with a top/bottom gradient. In the bridge assembly 306a (FIG. 4A), the distance between apertures 310 is modified, and this affects the area of some of the apertures 310 as well as the total quantity of copper in each bridge 308. For example, aperture 310a′ is a distance, d₉ , from aperture 310b′, where aperture 310b′ is elongated in the horizontal direction and thus has a bigger area than aperture 310b (FIG. 3A). Aperture 310b′ is a distance, d₁₀ , from aperture 310c′, where aperture 310c′ is elongated in the horizontal direction and thus has a bigger area than aperture 310c. Aperture 310c′ is a distance, d₁₁ , from aperture 310d′, where aperture 310d′ is elongated in the horizontal direction and thus has a bigger area than aperture 310d, where d₉<d₁₀<d₁₁ .

Where the apertures 310 are larger, the total quantity of copper in the bridge 308 decreases. Thus, for example, bridge 308b′ has less copper than the bridge 308b because aperture 310b′ is larger than aperture 310b. The quantity of copper in each bridge 308 can be modified by changing the cross-sectional areas of either or both of the bridge top 312 and bridge bottom 314, changing the size of the aperture 310, and/or changing the distance between apertures.

Looking at the bridge assembly 306b′ (FIG. 4B), the distance between apertures 310 is modified, and this affects the area of some of the apertures 310 as well as the total quantity of copper in each bridge 308. For example, aperture 310e′ is a distance, d₁₂ , from aperture 310f′, where aperture 310f′ is elongated in the horizontal direction and thus has a bigger area than aperture 310f (FIG. 3B). Aperture 310f′ is a distance, d₁₃ , from aperture 310g′, where aperture 310g′ is elongated in the horizontal direction and thus has a bigger area than aperture 310g. Aperture 310g′ is a distance, d₁₄ , from aperture 310h′, where aperture 310h′ is elongated in the horizontal direction and thus has a bigger area than aperture 310h, where d₁₂<d₁₃<d₁₄ .

For both bridges 306a′ and 306b′, the result is that the total quantity of copper in bridge 308a′ may be less than in bridge 308a due to the change in the horizontal direction, likewise for 308b′/308b, 308c′/308c, and 308d′/308d. Thus, the quantity of copper in each bridge 308 can be varied in terms of the cross-sectional area of the bridge tops 312 and bridge bottoms but can also be varied in the horizontal direction by varying the distance between apertures 310, whether than means changing the size of the apertures or moving them relative to one another. By having gradient and/or varying cross-sections from each bridge, moving from the center of the bridge assembly outward, better control of the arc/melt pattern can be achieved.

The effect is to increase the energy needed to melt the bridges close to the center, which are going to arc first, and then there is less energy for the bridges farther away from the center. This helps to disperse the copper into a larger dispersion pattern further into the filler to help create a region of high resistance, which is important for open state resistance. Further, in exemplary embodiments, the fuse element assembly 200 enhances the overall fuse thermal performance by forcing more of the high energy arcing toward the center of the fuse, resulting in less energy as the arcing energy moves outward, therefore helping to contain the total arcing/energy inside the fuse and not allowing the arcing energy to escape outside the fuse.

In exemplary embodiments, by varying the quantity of copper in each bridge, whether in a horizontal direction, a vertical direction, or by changing the aperture size, adjacent bridges can be configured so that the bridge closest to the center 304 has the least quantity of copper, and thus arcing and subsequent melting of that bridge will occur first, the next adjacent bridge has slightly more copper, and so on, until the bridge closest the terminal has the most (largest quantity of) copper of the series of bridges. The concept of causing arcing/melting events in a linear fashion from the center of the fuse element to the terminals can apply to virtually any fuse design in which the fuse element contains bridges. Automobile fuses, specifically for the electrical vehicle (EV) market, are particularly attractive due to their stringent OSR requirements.

In exemplary embodiments, the fuse element assembly 200 is stamped from a single piece of copper, which usually does not vary in thickness. However, it is possible to vary the amount of copper in each bridge by varying the thickness of the copper from one bridge to another. Thus, the bridge closest the center of the fuse element may be thinner while the thickness of each succeeding bridge increases. Although technically more challenging, varying the thickness of the copper for each succeeding bridge may provide a viable solution for some applications. Thus, expansion or reduction of the amount of copper in any dimension can produce the desired effect of having the bridges closest to the center arcing, then melting first, followed by the adjacent bridge, and so on, with the bridge closest the terminal arcing and melting last.

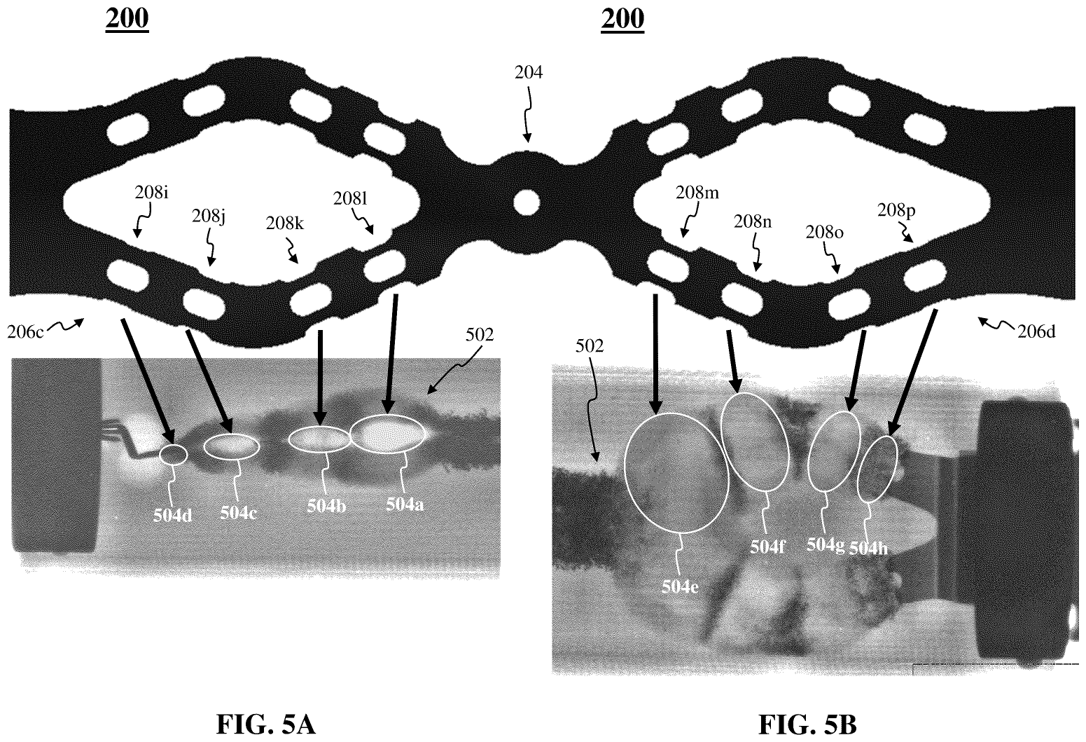

FIGS. 5A-5B are representative drawings of x-rays of the fuse element assembly 200 of FIG. 2A, according to exemplary embodiments. FIG. 5A is a side view x-ray of the bridge assembly 206c of the fuse element assembly 200 and FIG. 5B is an overhead view x-ray of the bridge assembly 206d of the fuse element assembly 200 following an open event. The x-rays are taken of the bridge 206c (FIG. 5A) and the bridge 206d (FIG. 5B) of the fuse element assembly 200.

In the side view (FIG. 5A), the bridge 208l of bridge assembly 206c creates melted copper deposit 504a, the bridge 208k creates melted copper deposit 504b, the bridge 208j creates melted copper deposit 04c, and the bridge 208i creates melted copper deposit 504d. Further, in exemplary embodiments, the melted copper deposit 504a forms in a first time period, t₁ , the melted copper deposit 504b forms in a second time period, t₂ , the melted copper deposit 504c forms in a third time period, t₃, and the melted copper deposit 504d forms in a fourth time period, t₄ , where t₁<t₂<t₃<t₄ . Thus, the melted copper deposit 504a happens first, followed by melted copper deposit 504b, then melted copper deposit 504c, then finally melted copper deposit 504d. The duration of each time period may be such that time periods overlap. For example, the melted copper deposit 504b forming in the second time period, t₂ , which may be occurring while the melted copper deposit 504a is still forming in the first time period, t₁ .

In the overhead view (FIG. 5B), the bridge 208m of bridge assembly 206d creates melted copper deposit 504e, the bridge 208n creates melted copper deposit 504f, the bridge 208o creates melted copper deposit 504g, and the bridge 208p creates melted copper deposit 504h (collectively, “melted copper deposits 504”). Further, in exemplary embodiments, the melted copper deposit 504e forms in a first time period, t₅ , the melted copper deposit 504f forms in a second time period, t₆, the melted copper deposit 504g forms in a third time period, t₇, and the melted copper deposit 504h forms in a fourth time period, t₈, where t₅<t₆<t₇<t₈ . Thus, the melted copper deposit 504e happens first, followed by melted copper deposit 504f, then melted copper deposit 504g, then finally melted copper deposit 504h. While it is possible that the bridges 504 of bridge assembly 206c melt at the same time as bridges of bridge assembly 206d, that is, t₁=t₅, t₂=t₆, t₃=t₇, and t₄=t₈ , it is possible that the arcing and melting events on either side of the center 204 are not uniform.

Surrounding the melted copper deposits 504 are fulgurite plumes 502, which are the fuse sand melted together. The melted copper deposits 504 closest to the center 204 are the largest. Melted copper deposit 504a is much larger than melted copper deposit 504d. Similarly, melted copper deposit 504e is much larger than melted copper deposit 504h.

This is in sharp contrast to a legacy fuse element assembly, such as the fuse element assembly 100 of FIG. 1A, where the melted copper deposits are all the same size, and thus there is uniform distribution of melted copper between the center of the fuse and the terminals, a condition in which there is some risk that a current will be able to travel between the terminals due to the uniform deposition of copper along the path between terminals.

In exemplary embodiments, the novel design of the fuse element assembly 200 extends the time allowed for the inner bridge (e.g., bridges 208l and 208m in FIGS. 5A and 5B, respectively) to expand into the fulgurite 502 at the center of the fuse. The fulgurite plumes 502 are larger at the center 204 and become much smaller closer to the terminals. An equal distribution of fulgurite means the fulgurite becomes resistors in series, so uniform fulgurite growth means a lower OSR. More fulgurite growth toward the center means higher insulation and more dispersion of the melted copper material. This mitigates the possibility of a current path forming between the terminals.

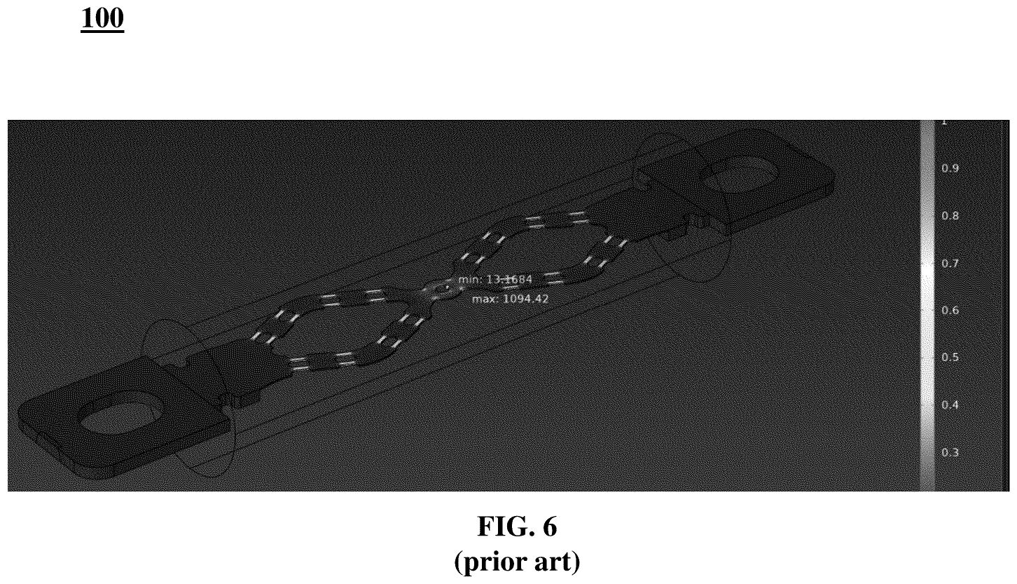

FIG. 6 is a representative drawing of a simulated short circuit of the fuse element assembly 100 of FIG. 1A, according to the prior art. FIG. 6 shows that, for each bridge, the same energy is released, meaning that all the bridges of the fuse element assembly 100 arc and subsequently melt together.

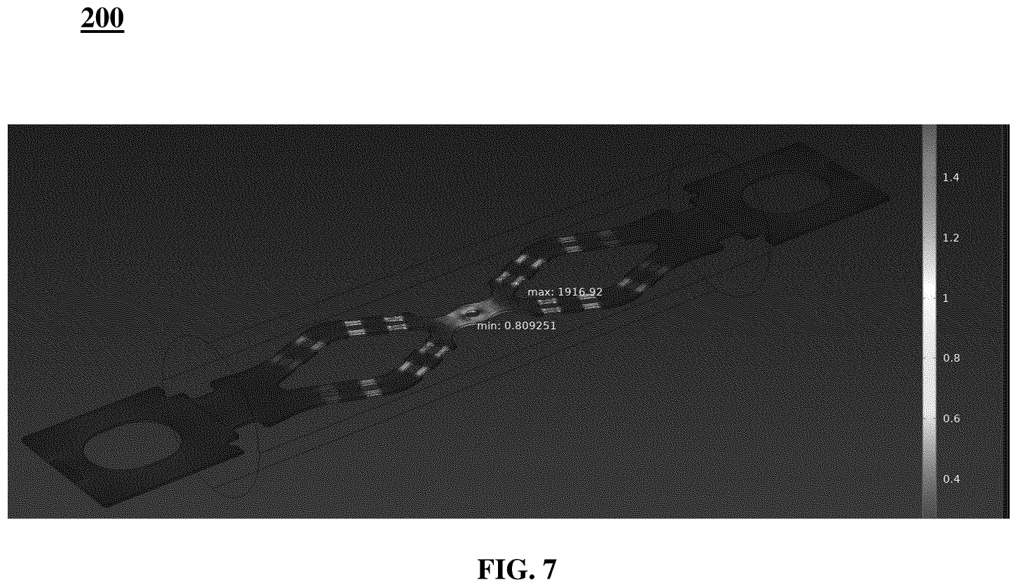

FIG. 7 is a representative drawing of a simulated short circuit of the fuse element assembly 200 of FIG. 2A, according to exemplary embodiments. FIG. 7 shows that, the bridges closer to the center experience higher energy, whereas the bridges closest to the terminals have much lower energy.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure is not limited to the described embodiments, but that it has the full scope defined by the language of the following claims, and equivalents thereof.

1. A fuse element assembly comprising a fuse element disposed between a first terminal and a second terminal, the fuse element, the first terminal, and the second terminal comprising an electrically conductive material, the fuse element comprising:
a center portion; and
a bridge assembly disposed between the center portion and the first terminal, the bridge assembly further comprising:
a first bridge comprising a first quantity of electrically conductive material; and
a second bridge comprising a second quantity of electrically conductive material, the first bridge being sandwiched between the second bridge and the center portion,
wherein the second quantity is greater than the first quantity.

2. The fuse element assembly of claim 1, the bridge assembly further comprising a third bridge comprising a third quantity of electrically conductive material, the second bridge being sandwiched between the first bridge and the third bridge, wherein the third quantity is greater than the second quantity.

3. The fuse element assembly of claim 2, wherein:
the first bridge comprises a first bridge top comprising a first cross-sectional area; and
the second bridge comprises a second bridge top comprising a second cross-sectional area, wherein the second cross-sectional area is greater than the first cross-sectional area.

4. The fuse element assembly of claim 3, wherein:
the third bridge comprises a third bridge top comprising a third cross-sectional area, wherein the third cross-sectional area is greater than the first cross-sectional area.

5. The fuse element assembly of claim 4, wherein:
the first bridge comprises a first aperture disposed beneath the first bridge top;
the second bridge comprises a second aperture disposed beneath the second bridge top; and
the third bridge comprises a third aperture disposed beneath the third bridge top.

6. The fuse element assembly of claim 5, wherein the first aperture, the second aperture and the third aperture are the same size.

7. The fuse element assembly of claim 5, wherein the first aperture has a first area, the second aperture has a second area, and the third aperture has a third area, wherein the first area is greater than the second area and the second area is greater than the third area.

8. The fuse element assembly of claim 5, wherein:
the first bridge comprises a first bridge bottom disposed beneath the first aperture;
the second bridge comprises a second bridge bottom disposed beneath the second aperture; and
the third bridge comprises a third bridge bottom disposed beneath the third aperture.

9. The fuse element assembly of claim 5, wherein the first aperture is a first distance from the second aperture and the second aperture is a second distance from the third aperture.

10. The fuse element assembly of claim 9, wherein the first distance is equal to the second distance.

11. The fuse element assembly of claim 9, wherein the first distance is smaller than the second distance.

12. A fuse element comprising a bridge assembly disposed adjacent a first side of a center portion, the bridge assembly comprising a plurality of bridges coupled to a terminal of a fuse, wherein:
each bridge of the plurality of bridges comprises a cross-sectional area different from each other bridge of the plurality of bridges;
a first bridge of the plurality of bridges is adjacent the center portion and has a first cross-sectional area; and
a last bridge of the plurality of bridges is adjacent the terminal and has a second cross-sectional area, the second cross-sectional area being larger than the first cross-sectional area.

13. The fuse element of claim 12, wherein an additional bridge of the plurality of bridges between the first bridge and the last bridge has a cross-sectional area greater than an adjacent bridge, wherein the adjacent bridge is closer to the center portion than the additional bridge.

14. The fuse element of claim 12, further comprising a second bridge assembly disposed adjacent a second side of the center portion, the second side being opposite the side, the second bridge assembly comprising a second plurality of bridges coupled to a second terminal of the fuse, wherein:
each bridge of the second plurality of bridges comprises a cross-sectional area different from each other bridge of the plurality of bridges;
a first bridge of the second plurality of bridges is closest the center portion and has the smallest cross-sectional area; and
a last bridge of the second plurality of bridges is closest the second terminal and has the greatest cross-sectional area.

15. The fuse element of claim 14, wherein an additional bridge of the second plurality of bridges between the first bridge and the last bridge has a cross-sectional area greater than an adjacent bridge, wherein the adjacent bridge is closer to the center portion than the additional bridge.

16. A fuse element comprising a bridge assembly disposed between a terminal and a center portion, the bridge assembly comprising a plurality of bridges, wherein, upon an opening event:
a first bridge of the bridge assembly arcs, then melts, in a first time period, into a first melted copper deposit having a first area; and
a second bridge of the bridge assembly arcs, then melts, in a second time period, into a second melted copper deposit having a second area, wherein the first bridge is closer to the center portion than the second bridge and the first time period is before the second time period.

17. The fuse element of claim 16, wherein the first area is larger than the second area.

18. The fuse element of claim 16, further comprising a second bridge assembly disposed between a second terminal and the center portion, the second bridge assembly comprising a second plurality of bridges wherein, upon an opening event:
a third bridge of the second bridge assembly arcs, then melts, in a third time period, into a third melted copper deposit having a third area; and
a fourth bridge of the second bridge assembly arcs, then melts, in a fourth time period, into a fourth melted copper deposit having a fourth area, wherein the third bridge is closer to the center portion than the fourth bridge and the third time period is before the fourth time period.

19. The fuse element of claim 18, wherein the third area is larger than the fourth area.

20. The fuse element of claim 19, wherein:
the first time period is equal to the third time period; and
the second time period is equal to the fourth time period.
